(19) United States
(12) Patent Application Publication
(10) Pub. No.: US 2001/0003092 A1
(43) Pub. Date: Jun. 7, 2001

(54) System and method relating to private telecommunication systems

(76) Inventor: Staffan Sjodin, Tyreso (SE)

Correspondence Address: Ronald L. Grudziecki, Esq., BURNS, DOANE, SWECKER & MATHIS, L.L.P., P.O. BOX 1404, Alexandria, VA, 22313-1404, US

(21) Appl. No.: 09/728,411

(22) Filed: Dec. 1, 2000

(30) Foreign Application Priority Data
Dec. 1, 1999 (SE) 9904346-5

(51) Int. Cl. H04Q 7/20

(52) U.S. Cl. 455/433; 455/422; 455/554; 455/555

(57) ABSTRACT

The present invention relates to a private microcellular telecommunications network comprising a number of network nodes (10,20,30,40) serving as home location nodes for a number of cordless telephones respectively and also keeping information relating to identity (authentication) and current location for the respective cordless telephones. Each network nodes serving as a home location node uses a distributed database function for the home location node functionality which is distributed among the network nodes when needed and it comprises means for using a separate connection (25) for sending enquiry messages and receiving reply messages. The invention also relates to a method of managing mobility in a microcellular private telecommunications network and to a network node in such a network.

### FIELD OF THE INVENTION

The present invention relates to a private microcellular telecommunications network comprising a number of network nodes serving as home location nodes for each a number of cordless telephones. The invention also relates to a method of managing mobility of cordless telephones in a microcellular private network. Still further the invention relates a network node in a private micro cellular telecommunications network serving as a home location node for a number of cordless telephones.

### STATE OF THE ART

A microcellular network comprises a number of network nodes such as for example PBXs (Private Branch Exchanges) or mobility serving means which also may include a functionality of serving as a PBX. A microcellular communications network may be comprised in a Digital European Cordless Telephone system (DECT). The DECT telephone system is for example described in ETSI Standard 301 175 (Radio Equipment and System: Digital Cordless European Telephone, Common Interface). Each cordless telephone in a micro cellular network has one of the network nodes as its home location storing data relating to the cordless telephone, such as the current location and authentication key. A microcellular network thus comprises a number of network nodes into which users of cordless telephones can roam.

When a user roams into a new area served by another node, here called the visited node, the home location node comprising a home data base has to be inquired about among others the authentication key and moreover the new updated or current location of the cordless telephone has to be stored into the home location data base. When a cordless telephone is roaming into an area served by another node than its home location node, i.e. a visited node, the visited node has to know how to set up a call to the home location node. This means that the visited node has to know, for each terminal, how to set up a call to its respective home location node. In state of the art systems an enquiry is sent from the visited node to the home location node on a switched ISDN-Q connection. The home location node then answers, also on the switched ISDN-Q connection and provides information about the authentication key. However, the fact that the visited node has to keep information about how to set up a call to all the home location nodes, is a drawback. Further yet, this means that the node has to analyse and find out which home location node is to call at location registering.

Moreover, when a calling party (also called an A-party) intends to make a call to another party, a called party or a B-party, a call is first switched to the home location node of the B-party and from thereon a call is switched to the current visited location of the B-party, if the B-party is not in an area served by its home location node. Routing is then performed via the home location node since the database of the node serving as a home location node for the B-party contains information about the current location of the B-party and moreover it contains information about the traffic parameters of the B-party. Moreover, if the calling A-party currently is at a visited node, the call may have to be switched via the home location node of the A-party as well meaning that, for a single call, a lot of calls actually have to be switched and set up involving a lot of signalling. This is a serious drawback and mobility management within a microcellular network can with the hitherto known systems not be handled in a satisfactory manner.

### SUMMARY OF THE INVENTION

What is needed is therefore a private microcellular telecommunications network with a number of network nodes serving as home location nodes for a number of cordless telephones respectively and which at least keep information relating to authentication and current location for the respective cordless telephones through which roaming as well as call set up from a first party to a second party facilitated.

Particularly a system is needed through which can be avoided that a visited node (or a node in general) has to keep information for all terminals about how to set up a call to the home location nodes of the respective cordless telephones. Particularly a system is needed through which information about a cordless telephone having another node as its home location node can be obtained in an easy manner and through which updated location information can be obtained for the respective cordless telephones. Particularly a system is needed through which information normally contained in a home location database associated with a home location node can be obtained without requiring an analyse to be performed to find out which home location node is to call at location registering. Particularly a system is needed through which a home location database as associated with a home location node can be distributed without any particular or additional functions are needed for the nodes to analyse which home location node to call at location registering.

Moreover a method of providing mobility management in a micro cellular network comprising a number of network nodes is needed through which the above mentioned objects can be achieved. A network node in a microcellular network is also needed through which the above mentioned objects can be met.

Therefore a private microcellular telecommunications network as initially referred to is provided through which the data base functionality is distributed when needed (on demand, or on request, directly or indirectly) among the network nodes using a separate signalling connection. Particularly each network node with a home location functionality comprises means for sending enquiry messages to all the other network nodes of the private network over a connection used for a signalling and means for storing information received in response messages obtained over said connection. In a very advantageous implementation an IP-network is used as a connection for signalling relating to enquiry messages and response messages. Most particularly the enquiry messages are sent using broadcasting. A broadcasting functionality may be included in the language used in the system, i.e. it is already supported for a broadcasting functionality, or a broadcasting functionality may be added. Still further it is possible to in some way send enquiry messages to all network nodes from a particular network node.

Particularly a network is provided in which, when a cordless telephone roams into an area served by another network node than the home location node, i.e. a visited node, an enquiry message is sent to all other network nodes in order to find the home location node. Advantageously the enquiry message at least contains information about the identity of roaming cordless telephone and advantageously the home location node recognizing the identity information sends a response message to the visited node and stores information about the current location into its associated or contained home location database. As referred to above, preferably an IP-network is used for sending enquiry messages, e.g. by a broadcast, and response messages. In a particular implementation the identity information comprises the Portable Unit Number (PUN) of the roaming cordless telephone and particularly the home location node answers with a message containing authentication key information relating to the identified cordless telephone.

Still further, in an advantageous implementation, for making a call from a calling cordless telephone also called an A-party, to a called cordless telephone, also called a B-party, an enquiry message is sent to all other nodes from the node currently serving the A-party, i.e. the node in which the calling party initiates the call to obtain information about the current location of the called party. Particularly, as also referred to above, an IP-network is used for the enquiry messages, particularly via broadcast. Still further, for setting up a call, the home location node identifying the cordless telephone to which a call is to be set up, sends a reply to the (broadcast) enquiry message to the node from which the call is initiated and a call is set up between the initiating node and the node at which a called party currently is located without routing via the home location node of any of the calling/called party if one or both is/are located at another node.

In an alternative implementation the visited node of the called party, i.e. the called party is not within an area covered by its own home location node, sends a reply to a broadcast enquiry message to the node from which the call initiated and a call is set up between the initiating node and the node at which the called party currently is located without routing via the home location node of any of the calling/called party if one or both thereof is/are located at another node.

In a particular implementation the response message replying to the (broadcasted) enquiry contains service profile data relating to the subscriber of the called party, then however, it is preferably the home location node of the called party that sends the response message.

In a particular implementation at least a number of the network nodes comprise PBX:es. In an alternative implementation at least some of the network nodes comprise mobility serving means communicating with PBX:es or including a PBX-functionality.

An example on a mobility serving means or a so called mobility server is discussed in U.S. patent applications Nos. 08/786,552 and 08/948,522 the contents of which herewith are incorporated herein by reference thereto.

In a particular implementation a microcellular network comprises means for signalling, e.g. sending broadcast enquiry messages and responses to broadcast enquiry messages over an IP-network and means for setting up calls via a public network using TLDN or a private ISDN-Q.

ISDN-Q is described in ECMA/143 “Basic Call”, ECMA/165 “Generic functions”, and ETSI EN 301 172 Ver. 1.4.1. and ETS S 300 239, Second Edition.

In other networks DPNSS may be used which relates to the British Telecom Standard BTNR 188.

Therefore also a method for managing mobility of cordless telephones in a microcellular private network is provided which comprises a number of network nodes. The method includes the steps of; assigning each cordless telephone to a network node serving as a home location node of the respective cordless telephone; sending enquiry messages to all the other of said network nodes from a node at which a first cordless telephone currently is located over a separate connection to obtain information about the home location node of the first cordless telephone or of another second cordless telephone; providing a response message to the enquiring node over the separate connection from a node able to respond to the request. Particularly the separate connection is carried over an IP-network, e.g an intranet or Internet. Another data communication network may also be used e.g. an ATM network (Assynchronous Transfer Mode) or a network implementing Packet Frame Relay.

In an advantageous implementation the method includes the steps of; broadcasting an enquiry message from a network node serving the area into which a cordless telephone is roaming to all other network nodes, which message contains at least identity information for the cordless telephone; recognizing the identity information in the node serving as a home location node of the roaming cordless telephone; sending a response message from the home location node to the visited node; storing information about the current location of the roaming cordless telephone in the home location node. Advantageously the response message contains authentication key information of the roaming cordless telephone.

In a particular implementation the method further includes the steps of, for setting up a call from a calling party (A-party) to a called party (B-party); sending out an enquiry, e.g. a broadcast message, from the node at which the calling party is located to all other nodes to obtain information about the current location of the called party, thus containing identity information about the B-party; sending a response message from a node able to identify the called party and knowing its current location to the enquiring node; setting up a call directly from the node serving the calling party to the node serving the called party. Particularly the node sending the response message is the home location node of the called party. The method may advantageously include the step of sending, together with the reply message, also service profile data together with authentication data and current location data relating to the called party. The provision and handling of service profile data is discussed in the copending patent application “A system and a method relating to microcellular telecommunication networks” filed on the same day and by the same applicant as the present invention and the content of which herewith is incorporated herein by reference. In an alternative implementation the node sending the response message is the network node currently serving the called party, i.e. the visited node. Thus, according to the different implementations it may be the home location node, or the visited node that sends a response message in case the B-party currently served by a visited node.

Advantageously an IP-network is used for signalling relating to enquiry messages and response messages and the method particularly includes the steps of using a public network using TLDN or a private ISDN-Q network for call set up. Particularly the network nodes are mobility serving means and/or PBX:es.

Therefore also a network node in a private microcellular network is provided, which node for example may be a PBX or a mobility serving means such as a mobility server which uses distributed databases for at least home location data and which comprises means for sending enquiry messages, particularly via broadcast, and response messages so as to provide for a distributed functionality of the home location database and in that a separate connection, e.g an IP network, is used for the enquiry messages and response messages.

In Swedish Patent Application “A system, an arrangement and method relating to interconnection of telecommunication network arrangements” filed on Oct. 14, 1999 by the same applicant, a system comprising a number of network arrangements such as PBX:es or mobility serving means is described which uses a first connecting system, e.g. a switched telephony system for speech connection supporting a basic call functionality and a second connecting system to provide support for additional service functionalities, wherein the second connecting system comprises an IP-based network. When a basic call, a speech connection, is established between such network arrangements which may be private, an IP connection is established substantially simultaneously over the second connecting system which connection is maintained throughout the duration of said call connection. The content of this application is herewith incorporated herein by reference thereto.

It is an advantage of the present invention that mobility management is facilitated in a microcellular network and in that a home location database can be distributed without any extra functions being required for a visited node for analysing which is the home location node to call at location registering. It is also an advantage that a call can be set up directly from a visited node of a called party to a visited node of a called party, which relates to a particular implementation. It is an advantage that roaming as well as call set up facilitated.

### BRIEF DESCRIPTION OF THE DRAWINGS

The invention will in the following be more thoroughly described in a non-limiting way and with reference to the accompanying drawings in which:

FIG. 1 schematically illustrates a network according to the invention,

FIG. 2 schematically illustrates a roaming cordless telephone,

FIG. 3 schematically illustrates the signalling when a cordless telephone makes a call to another cordless telephone,

FIG. 4 is a flow diagram describing the basic procedual steps when a cordless telephone roams into an -area served by a network node,

FIG. 5 is a flow diagram describing the procedural steps that take place in the home location node of a roaming cordless telephone as well as in other nodes,

FIG. 6 is a schematical flow diagram describing the basic procedural steps when a call is made to a cordless telephone, and

FIG. 7 is a schematically flow diagram describing the. procedure at reception of an enquiry message.

### DETAILED DESCRIPTION OF THE INVENTION

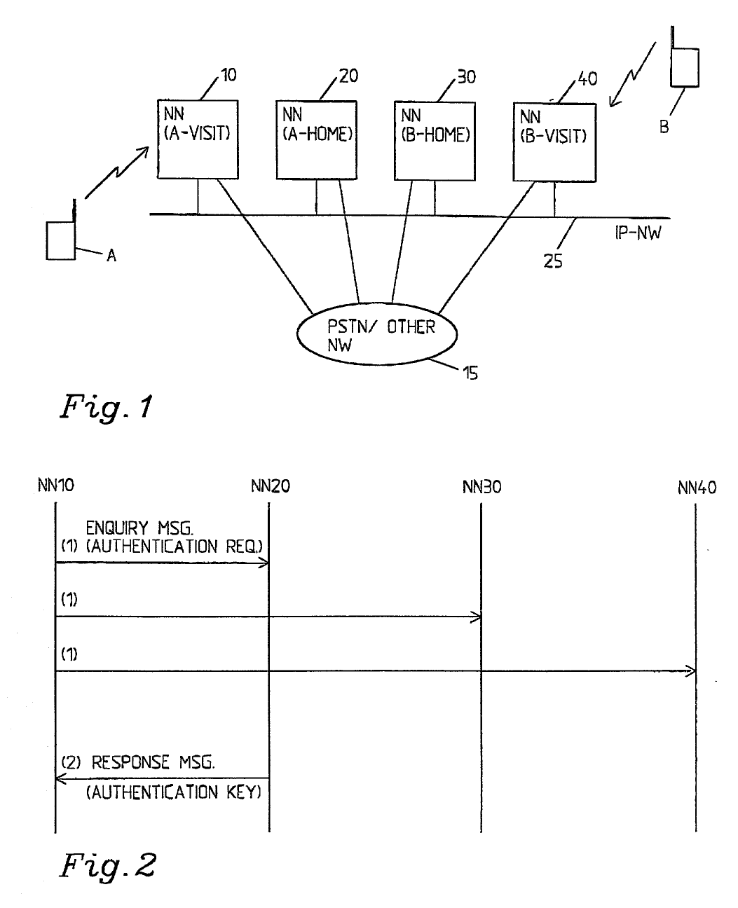

FIG. 1 very schematically illustrates a microcellular network comprising network nodes NN 10, 20, 30, 40. Two cordless telephones A, B are also illustrated. In this particular embodiment it is supposed that NN 10 is the network node currently serving cordless telephone A, i.e. the network node serving the area that A currently visits. NN 20 is supposed to be the home location node of cordless telephone A. NN 30 is supposed to be the home location node of cordless telephone B whereas cordless telephone B currently is visiting NN 40. The network nodes may for example be PBX:es or mobility serving means, e.g. mobility servers. A mobility server may also include the functionality of a PBX or it may be associated with a PBX, e.g. arranged between the PBX and a number of radio exchanges. It is illustrated that a public network (for example) e.g. using TLDN (Temporary Location Designation Number) as more thoroughly discussed in the Patent Application “A system, an arrangement and a method relating to interconnection of telecommunication network arrangements” which was incorporated herein by reference, or alternatively a private ISDN-Q network is used, 15 for connection of calls etc. However for signalling relating to enquiry (broadcast) messages and response messages according to the present invention an IP-network 25 (an intranet or Internet using TCP/IP, Transmission Control Protoco/Internet Protocol) is used. Thus IP-network 25 is used for signalling such that information can be provided to/from a node serving as a home location node, i.e. containing home data base information of a cordless telephone. This means that the home location database functionality is distributed on request, when an enquiry message is sent out (broadcasted). If for example the user of cordless telephone A roams into NN 10 and NN 10 does not know which is the home location node of A, NN 10 sends an enquiry message to all the other nodes, NN 20, NN 30, NN 40 within the customer area, or within the private network, preferably/using broadcast messaging. In a particular implementation such an enquiry message contains information about the identity of cordless telephone A, particularly the Portable Unit Number (PUN). The node which then recognizes for example the PUN number, then answers and sends a reply message containing the authentication key of A. In this case it is NN 20 that recognizes e.g. the PUN number. NN 10 at the same time stores information about which node cordless telephone A currently is registered in, in this case NN 10. All this signalling is carried over the network 25.

If for example a call is to be set up from the A-party to a B-party the node at which the A-party initiates the call, in this case NN 10, makes a broadcast enquiry (or simply sends messages to 10 all the other nodes the private network, i.e. here NN 20, NN 30, NN 40) to obtain information about the current location of the B-party. It is supposed that the home location node NN 30 of the B-party recognizes the identity information contained in the enquiry message thus containing information about the B-party, answers the enquiry as to where the B-party currently is located, in this case NN 40, i.e. the B-party is not at its home location. A call can now be set up directly from the visited node of the A-party, NN 10, to the visited node of the B-party, NN 40, using a PSTN network or another network is. Thus a call to the B-party can be set up without any switching via the home node of the B-party.

FIG. 2 schematically illustrates the signalling when a cordless telephone roams into an area served by NN 10. NN 10 then sends an enquiry message comprising an authentication request (1) to all the other networks, NN 20, NN 30, NN 40 belonging to the customer area or comprised within the private network. Here it is supposed that NN 20 recognizes the cordless telephone e.g. cordless telephone A, as belonging to NN 20, i.e. NN 20 is its home location node. NN 20 then stores the identity or NN 10 as being the visited node and sends the authentication key to NN 10 in response message (2). The cordless telephone can now initiate calls from the new location, here NN 10.

It is now supposed that e.g. cordless telephone A wants to make a call to another cordless telephone B. When the number to cordless telephone A is dialed NN 10 sends an enquiry message comprising a location request to determine where cordless telephone B is located. This enquiry message (1) is sent to all the other network nodes as in the preceding case, namely NN 20, NN 30, NN 40. NN 30 being the home location of B then answers with the response message (2) comprising locating information. NN 10 is now able to set up a call directly from NN 10 to, in this case NN 30 where the B-party is located. The call can be set up via for example the public network using TLDN or via a private ISDN-Q network.

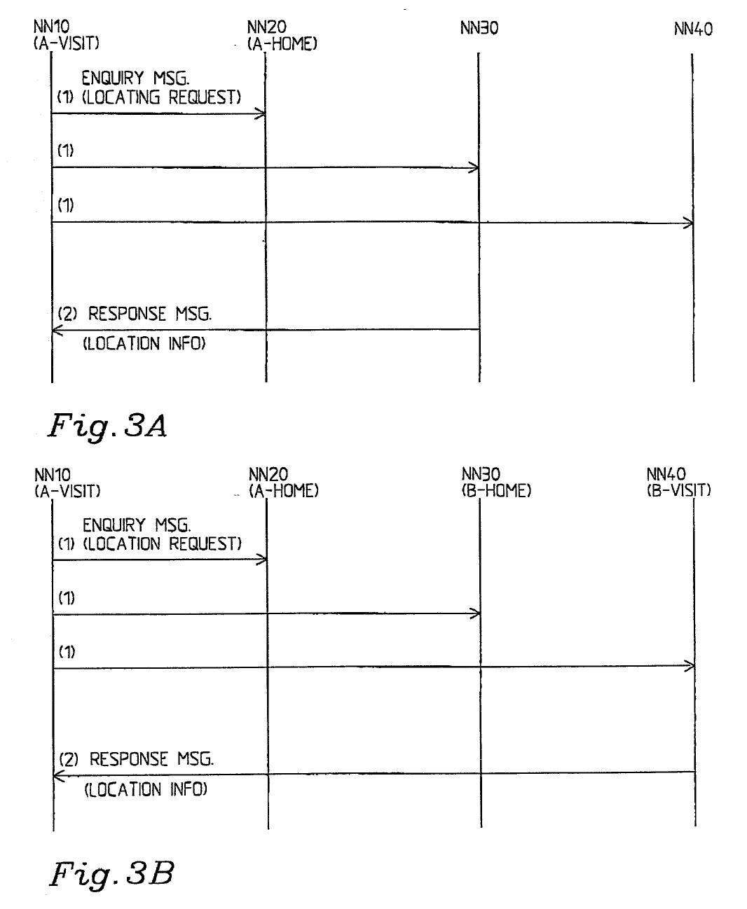

In FIG. 3B an alternative embodiment is illustrated in which again cordless telephone A wants to make a call to cordless telephone B. When the number to the cordless telephone is dialled, NN 10 sends an enquiry message (1) comprising a location request to determine where the portable telephone B is located. In this case it is however supposed that the node visited by B, NN 40, sends a reply message (2) comprising locating information. Thus this constitutes an alternative to the-embodiment disclosed in FIG. 3A in which the home location node NN 30 of B sends a reply message (although B actually is in an area served by NN 40). If it is the home location node that provides the reply message, it is easier to extend the functionality through also sending profile data for the cordless telephone but, as referred to in FIG. 3B, it is also possible to have the visited node NN 40 provide the location information.

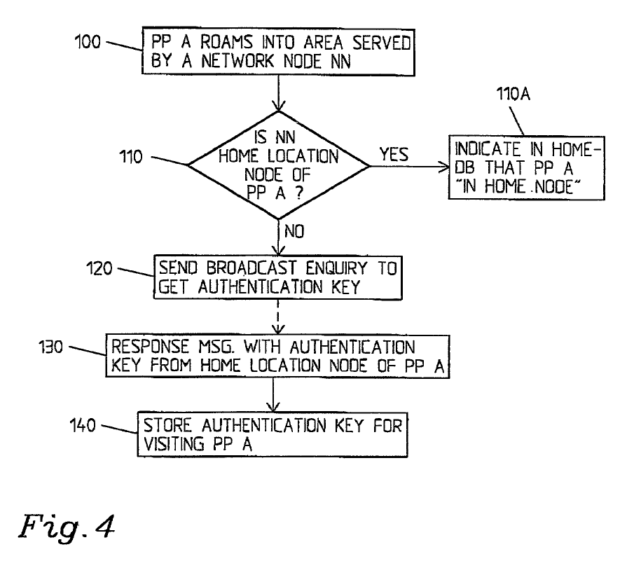

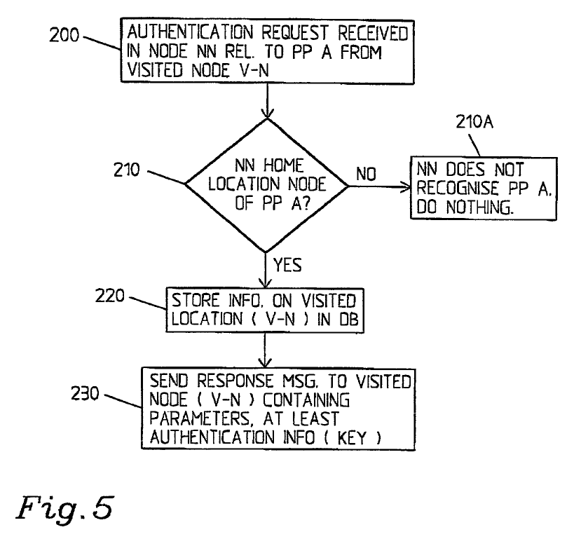

FIG. 4 is a flow diagram describing a cordless telephone PPA roaming into an area served by a network node NN, 100. First is examined if NN is the home location of PPA, i.e. if PPA roams into its home location, 110. If yes, it is indicated in the home location database of the home location node that PPA is in its home node, 110A. If not, a broadcast enquiry is sent to all the other network nodes of the private network or of the customers area, to obtain the authentication key, 120. It is then supposed that a response message is obtained from the home location node of PPA containing the authentication keys 130. Thus, the home location node recognizes PPA. Node NN into which portable PPA roams, then stores the authentication key, 140.

In FIG. 5 it is schematically illustrated what happens when a node receives an authentication request. Thus, it is first supposed that an authentication request is received in node NN relating to PPA. It is supposed that the authentication request is received from the node visited by PPA, e.g. the node V-N, 200. It is then examined whether NN is the home location node of PPA, 210. If not, NN does not recognize PPA and NN does not do anything, 210A. If on the other hand NN recognizes PPA as being its home location, it stores information about the visited location (V-N) in its home location database, 220. The location information can either be obtained through information in a message parameter or it can be obtained through identifying the sender of the message (i.e. the visited node). The home location node then sends a reply message to the visited node (V-N) containing a number-of parameters, at least authentication information or the authentication key. In advantageous embodiments other useful parameters can also be sent such as for example class of service etc., 230.

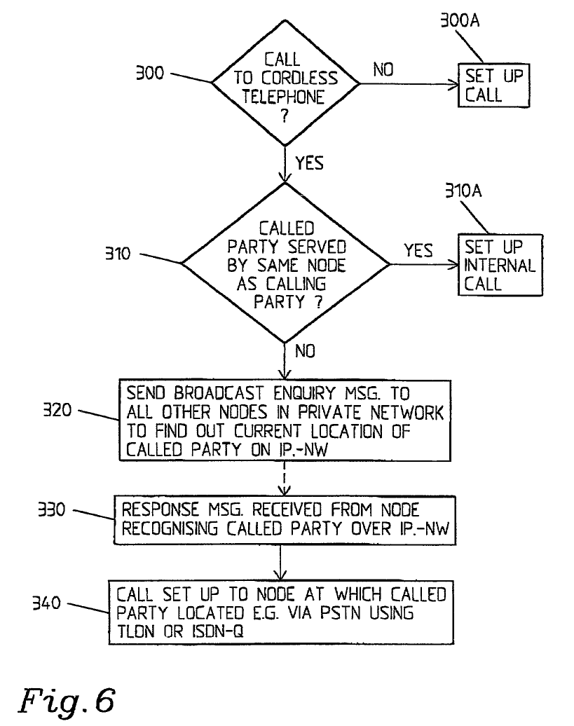

FIG. 6 is a flow diagram describing the procedure when a call is to be set up.

First it is supposed that a number is dialed and this number is examined to find out if it is a call to a cordless telephone, i.e. a portable telephone or not. If it is not a call to a cordless telephone, a call set up procedure is initiated in a conventional manner since it is here supposed that it is a call to a fixed telephone, 300. This procedure is not relevant to the present invention. If however it is established that it is a call to a cordless telephone, an examination is performed to find out whether the called party is served by the same node as the calling party, 310. If yes, an internal call is set up, 310A, since it means that both the called and the calling party are located in the same system or are both served by the same network node. If however they are not served by the same node, a broadcast enquiry message is sent to all other nodes in the private network or all related network nodes to enquiry about the current location of the called party. This broadcast enquiry is sent on an IP-network, 320. Then an answer is awaited, and it is supposed that a reply message is received from a node recognizing the called party, 330. The reply message is also sent of the IP-network. Finally a call is set up to the node at which the called party is located, e.g. via PSTN using TLDN or ISDN-Q as referred to earlier, 340 As referred to earlier, the response message may be provided by the home location node of the called party or the node that it visits.

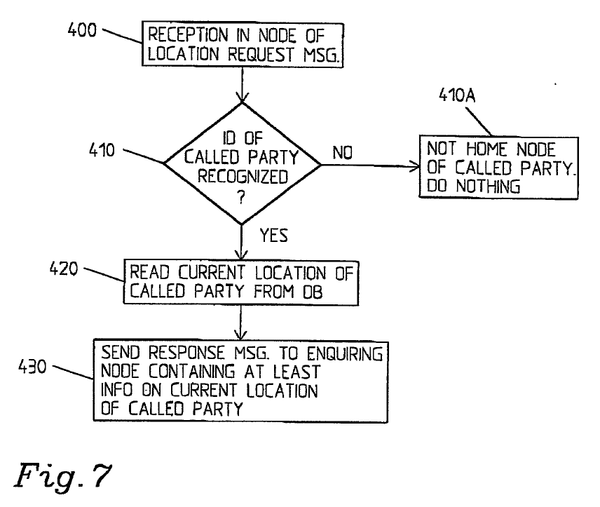

Finally FIG. 7 is a flow diagram describing the procedure when a location request message is received at a call to a cordless telephone. Thus it is supposed that a location request message is received in a node, 400. Then it is established in the respective node if the ID or the identity information of the called party can be recognized, 410. If not, the node is not the home node of the called party. (And/or not the node visited by the called party.). Then nothing is done, 410A. If however the node recognizes the called party, (if it is the home node) the current location information of the called party is read from the data base, 420. Subsequently a response message is sent to the enquiring node. This reply message at least contains information about the current location of the called party, 430. The answer contains the current location and in an advantageous implementation also profile data

It should be clear that the invention is not limited to the explicitly illustrated embodiments but it can be varied in a number of ways without departing from the scope of the appended claims.

1. A private microcellular telecommunications network comprising a number of network nodes (10, 20, 30, 40), each of which serving as a home location node for a number of cordless telephones and at least keeping information relating to authentication and current location for the respective cordless telephones,
characeterized in
that each network node serving as a home location node (20, 30) uses a distributed database for the home location node functionality, the database functionality being distributed among the network nodes (10, 20, 30, 40) when needed or on request by another node using a separate connection (25).

2. A network according to claim 1,
characterized in
that each network node (20, 30) with a home location functionality comprises means for sending enquiry messages to all the other network nodes (10, 20, 30, 40) of the private network over said connection (25) used for signalling, and means for storing information received in response messages obtained over said connection (25).

3. A network according to claim 2,
characterized in
that an IP-net (25) is used as connection for signalling relating to enquiry messages and response messages.

4. A network according to claim 2 or 3,
characterized in
that enquiry messages are sent using broadcasting.

5. A network according to claim 2, 3 or 4,
characterized in
that when a cordless telephone (A) roams into an area served by another network node (10) than the home location node (20), i.e. a visited node, an enquiry message is sent out to all other network nodes (20, 30, 40) in order to find the home location node.

6. A network according to claim 5,
characterized in
that the enquiry message contains at least information about the identity of the roaming cordless telephone, and in that the home location node (20) recognizing the identity information sends a response message to the visited node (10) and stores information about the current location into the database.

7. A network according to claim 6,
characterized in
that the identity information comprises the Portable Unit Number (PUN), and in that the home location node (20) answers with a message containing authentication key information relating to the identified cordless telephone.

8. A network according to any one of the preceding claims,
characterized in
that for routing a call from a calling cordless telephone (A-party) of a network to a called cordless telephone (B-party), an enquiry message is sent to all other nodes (20, 30, 40) from the node (10) in which the calling party initiates the call to obtain information about the current location of the called party (B-party).

9. A network according to claim 8,
characterized in
that the home location node (30) sends a reply to a broadcast enquiry message to the node (10) from which the call initiates, and in that a call is set up between the initiating node (10) and the node (40) at which the called party currently is located without routing via the home location node of any of the calling/called party if one or both is/are located at another node.

10. A network according to claim 8,
characterized in
that the visited node (40) of the called party sends a reply to a sent out broadcast enquiry message to the node (10) from which the call initiates, and in that a call is set up between the initiating node (10) and the node (40) at which the called party currently is located without routing via the home location node of any of the calling/called party if one or both is/are located at another node.

11. A network according to claim 9,
characterized in
that the response to the sent out (broadcast) enquiry contains service profile data of the subscriber of the called party.

12. A network according to any one of the preceding claims,
characterized in
that at least a number of the network nodes comprise PBX:es.

13. A network according to any one of the preceding claims,
characterized in
that at least some of the network nodes (10, 20, 30, 40) comprise mobility serving means communicating with PBX:es or including a PBX-functionality.

14. A network according to any one of the preceding claims,
characterized in
that it comprises means for signalling, e.g. sending broadcast enquiry messages, responses to broadcast enquiry messages over an IP-network and means for setting up calls via a public network using TLDN or a private ISDN-Q.

15. A method for managing mobility of cordless telephones in a microcellular private network comprising a number of network nodes, including the step of:
assigning each cordless telephone to a network node serving as a home location node of the respective cordless telephone,
characterized in
that it further comprises the steps of:
sending enquiry messages to all the other of said network nodes from a node at which a first cordless telephone currently is located over a separate connection to obtain information about the home location node of the first cordless telephone or of another second cordless telephone,
providing a response message to the enquiring node over the separate connection from a node able to respond to the request.

16. A method according to claim 15,
characterized in
that the separate connection is a data communication network, e.g. an IP-network.

17. A method according to claim 15 or 16,
characterized in
that it comprises the steps of:
broadcasting an enquiry message from a node serving the area into which a cordless telephone is roaming to all other nodes, which message contains at least identity information for the cordless telephone,
recognizing the identity information in the node serving as a home location node of the roaming cordless telephone,
sending a response message from the home location node to the visited node, and
storing information about the current location of the roaming cordless telephone in the home location node.

18. A method according to claim 17,
characterized in
that the response message contains authentication key information for the roaming cordless telephone.

19. A method according to any one of claims 15-18,
characterized in
that it further comprises the steps of for setting up a call from a calling party (A-party) to a called party (B-party):
sending out an enquiry, e.g. a broadcast message, from the node at which a calling party is located to all other nodes to obtain information about the current location of the called party,
sending a response message from a node able to identify the called party and knowing its current location to the enquiring node, and
setting up a call directly from the node serving the calling party to the node serving the called party.

20. A method according to claim 19,
characterized in
that the node sending the response message is the home location node of the called party irrespectively of whether the called party is visiting another node or not.

21. A method according to claim 20,
characterized in
that it further includes the step of:
sending profile data together with authentication data and current location data relating to the called party in the response message.

22. A method according to claim 19,
characterized in
that the node sending the response message is the visited node of the called party.

23. A method according to any one of claims 15-22,
characterized in
that it comprises the steps of:
using an IP-network for signalling relating to enquiry messages and response messages, and
using a public network using TLDN or a private ISDN-q network for call set up.

24. A method according to any one of claims 15-23,
characterized in
that the network nodes are mobility serving means or PBX:es.
